(19) United States
(12) Patent Application Publication
(10) Pub. No.: US 2012/0243031 A1
(43) Pub. Date: Sep. 27, 2012

(54) GPU ACCELERATED COLOR ANALYSIS AND CONTROL SYSTEM

(75) Inventor: Shane Matthew Cain, Carlsbad, CA (US)

(73) Assignee: KONICA MINOLTA LABORATORY U.S.A., INC., San Mateo, CA (US)

(21) Appl. No.: 13/072,649

(22) Filed: Mar. 25, 2011

(51) Int. Cl. G06K 15/02

(52) U.S. Cl. 358/1.15

(57) ABSTRACT

A graphic processing unit (GPU) accelerated image analysis and control system and method for implementing a process of managing parallel processing algorithms on one or more GPU devices. An exemplary embodiment of the process includes the steps of configuring the multiple GPU devices to enable multiple applications to be executed by the GPU devices, the multiple applications being used for GPU accelerated image analysis, assigning the multiple applications to the multiple GPU devices in accordance with the configurations of the multiple GPU devices, and having the multiple GPU devices execute the assigned applications in parallel, thereby performing the GPU accelerated image analysis. When a multi-GPU model is enabled on two or more GPU devices assigned to a printing application, a GPU distribution algorithm is invoked for performing the GPU accelerated image analysis simultaneously on the two or more GPU devices.

### BACKGROUND OF THE INVENTION

1. Field of the Invention

This invention relates generally to color analysis in printing systems, and more particularly it relates to graphic processing unit (GPU) accelerated color analysis and control systems.

2. Description of Related Art

Color analysis has become an often needed step in a color printing process. Often times the pages to be printed are in portable document format (PDF) that has color contents. The conventional implementation for detecting color in PDF pages typically consists of rasterizing all page contents to an image in memory after which each image pixel (“sample”) is analyzed for color. Depending on the page contents, the process of rasterizing and analyzing each page image sample is computationally intensive which can monopolize shared system resources (e.g. central processing unit (CPU) time and system memory) and delay the acquirement and display of PDF page information to the application user.

### SUMMARY

The present invention is directed to a GPU accelerated color analysis and control system.

An object of the present invention is to provide a method for managing parallel processing algorithms (such as those used for accelerating PDF page color analysis) on a GPU device.

A further object of the present invention is to provide a system for controlling and configuring the GPU device parallel processing management method in a distributed computing environment to efficiently utilizing a host system containing multiple GPU devices.

To achieve these and/or other objects, as embodied and broadly described, the present invention provides a GPU accelerated color analysis and control system. In one preferred embodiment, the present invention system includes one or more data processing apparatus each having a non-transitory memory storing a computer software program and a processor executing the computer software program, wherein the computer software program includes program code configured to cause at least one data processing apparatus to execute a process implementing the present invention method.

In another preferred embodiment, the present invention includes a computer software program product having a computer readable program code embedded in a computer usable non-transitory storage medium for controlling at least one data processing apparatus, where the computer readable program code is configured to cause at least one data processing apparatus to execute the process implementing the present invention method.

An exemplary system of one preferred embodiment of the present invention includes a print server having multiple GPU devices and one or more printers where the print server and printers are arranged in a distributed computing environment.

An exemplary process of one preferred embodiment of the present invention includes the steps of configuring the multiple GPU devices to enable multiple applications to be executed by the GPU devices, the multiple applications being used for GPU accelerated image analysis, assigning the multiple applications to the multiple GPU devices in accordance with the configurations of the multiple GPU devices, and having the multiple GPU devices execute the assigned applications in parallel, thereby performing the GPU accelerated image analysis.

In another preferred embodiment, the present invention includes a system for utilizing multiple graphic processor unit (GPU) devices in a printing system comprising at least one data processing apparatus having a non-transitory memory storing a computer software program and a processor executing the computer software program, wherein the computer software program includes program code configured to cause the at least one data processing apparatus to execute a process

In still another preferred embodiment, the present invention includes a computer software program product having a computer readable program code embedded in a computer usable non-transitory storage medium for controlling at least one data processing apparatus, where the computer readable program code is configured to cause at least one data processing apparatus to execute the process implementing the present invention method.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary print shop arrangement where embodiments of the present invention may be implemented.

FIG. 2 is a schematic block diagram illustrating an exemplary print server according to an embodiment of the present invention.

FIG. 3 is a schematic block diagram illustrating an exemplary print shop computer according to an embodiment of the present invention.

FIG. 4 is a schematic block diagram illustrating an exemplary printer according to an embodiment of the present invention.

FIG. 5 is a schematic block diagram illustrating an exemplary GPU device according to an embodiment of the present invention.

FIG. 6 is a schematic flow-chart diagram illustrating an exemplary overview of a GPU accelerated control system architecture according to an embodiment of the present invention.

FIG. 7 is a schematic flow chart diagram illustrating the steps of an exemplary process implementing a GPU accelerated color analysis method according to an embodiment of the present invention.

FIG. 8 is a representative screen-shot diagram illustrating a main dialog window of the acceleration control center module of the software program implementing a GPU accelerated color analysis method according to an embodiment of the present invention.

FIG. 9 is a representative screen-shot diagram illustrating the main dialog window of the acceleration control center module of the software program implementing a GPU accelerated color analysis method according to an embodiment of the present invention, showing the “Auto” option of “Enable Acceleration” selected.

FIG. 10 is a representative screen-shot diagram illustrating the main dialog window of the acceleration control center module of the software program implementing a GPU accelerated color analysis method according to an embodiment of the present invention, showing the “Manual” option of “Enable Acceleration” selected.

FIG. 11 is a representative screen-shot diagram illustrating the application assignment dialog window of the acceleration control center module of the software program implementing a GPU accelerated color analysis method according to an embodiment of the present invention.

FIG. 12 is a representative screen-shot diagram illustrating the add application settings dialog window of the acceleration control center module of the software program implementing a GPU accelerated color analysis method according to an embodiment of the present invention.

FIG. 13 is a schematic flow-chart diagram illustrating an exemplary distribution algorithm under the “Multi-GPU” mode based for an exemplary type of color analysis, according to an embodiment of the present invention.

FIG. 14 is a schematic flow-chart diagram illustrating an exemplary GPU accelerated parallel image processing algorithm for an exemplary color detection analysis, according to an embodiment of the present invention.

### DETAILED DESCRIPTION OF PREFERRED EMBODIMENTS

Embodiments of the present invention provide a graphic processing unit (GPU) accelerated color analysis and control method and system. The present invention method may be implemented by a computer software program that has program codes and instructions for implementing the steps of the present invention.

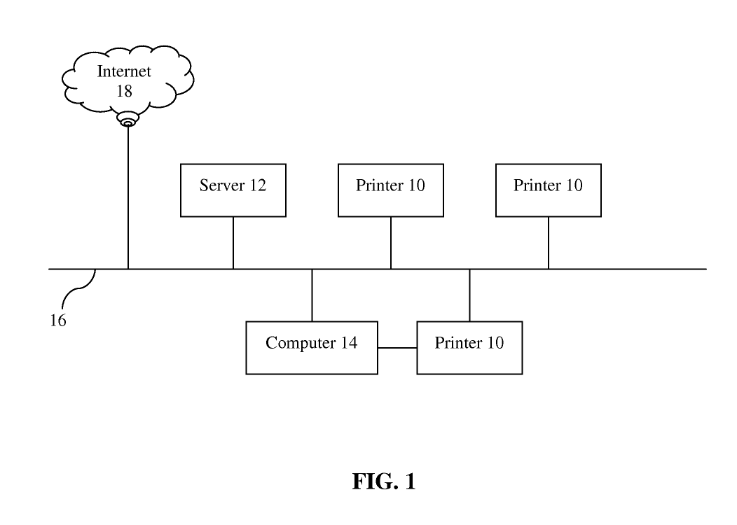

Referring to FIG. 1, there is shown a schematic block diagram illustrating an exemplary print shop arrangement where embodiments of the present invention may be implemented. In this patent application, the term “print shop” refers to an environment of professional print shops, publishing workshops, and similar establishments, where a variety of print requests (including print on demand (POD) requests), such as large-volume duplication and large document printing, needs to be processed and completed by utilizing multiple printers within a specified turn-around time.

In the exemplary print shop printing system set up or arrangement or configuration shown in FIG. 1, a multiplicity of color and/or black and white printers 10 are connected to and controlled by a printer shop server 12 through a data communication channel 16 which may be a wired or wireless network, a serial bus or a dedicated cable, which in turn can also be connected to an external computer network such as the Internet 18 so that the server 12 may remotely communicate with other remote servers and computers (not shown) via the Internet 18. One or more of the printers 10 may also be directly connected to and controlled by a computer 14 which may be networked through the data channel 16. Other devices (not shown) may also be connected to the server 12, the local computer 14 or network channel 16, such as scanners, finishing devices, etc., as part of the printing system set up or arrangement of the print shop. The print shop system may also include a number of “off-line” (or “off-network”) devices (not shown) that are not connected to the network, which devices may be any type of devices used in the print shop, such as finishing devices, prepress devices, etc.

In addition, in this application, the term “printer” may refer to small desk-top printers typically seen in an office environment, or large digital printing systems used in print/copy departments at large organizations or professional print shops. The term may also cover other similar image and document processing devices such as copiers or multifunction (“all-in-one”) printers that also have copier, scanner and/or facsimile functions. The printer may be directly attached to a computer or server locally, or connected to a computer or server through a network remotely, where the computer or server are used to manage a print job to be processed by the printer. The printer may have multiple paper trays to store paper of various sizes, color, and types. Further, the printer may be equipped with a sophisticated output sorting mechanism with multiple output trays to perform collate printing or other print finishing functions.

It is understood that while FIG. 1 shows a print shop environment, the present invention is not limited to any physical setting of a print shop or network, and can be applied to a printing system having a distributed setting where printers at different locations are connected to one print shop server. In particular, it should be apparent that one or more of the components of the printing system can communicate with the rest of the system via virtual private network (VPN) or similar means through the Internet 18.

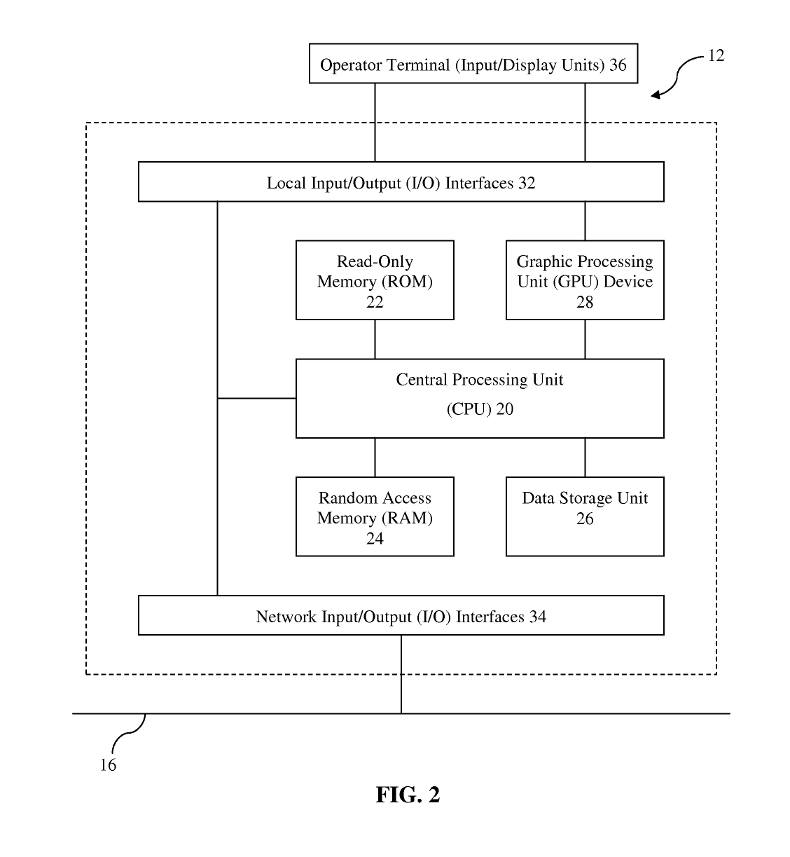

Referring to FIG. 2, there is shown a schematic block diagram illustrating an exemplary print server 12 according to an embodiment of the present invention. As shown in FIG. 2, the print shop server 12 typically includes a central processor unit (CPU) 20 that controls the function and operation of the server 12 and execute computer instructions and programs that may be installed or saved on a read only memory (ROM) 22, a random access memory (RAM) 24, or a data storage unit 26 (such as a hard disc drive) coupled to the CPU 20. One or more print shop operator terminals 36 (each may have its display and input units) may be connected to the server 12 to enable print shop operators and/or users to interact with the server 12 and/or the rest of the print shop system. Alternatively the server 12 may have its own integrated display and input units to enable print shop operators and/or users to interact with the server 12 and/or the rest of the print shop system. The server 12 typically has local input/output (I/O) interfaces 32 for connection with the user terminal 36, and network I/O interfaces 34 for connection to the data communication channel 16. Through the network channel 16 the server 12 is also connected to the external computer network such as the Internet 18 so that the server 12 can remotely communicate with other remote servers and computers via the Internet 18. The server 12 also has a graphic processing unit (GPU) device 28 such as a graphic card for processing graphic data or images for displaying on the display unit of the operator terminal 36. Alternatively the GPU device 28 may be part of the CPU 20 or part of an integrated circuit (IC) chip that also contains the CPU 20. It is understood that print shop server 12 may be any suitable computer or any suitable data processing apparatus.

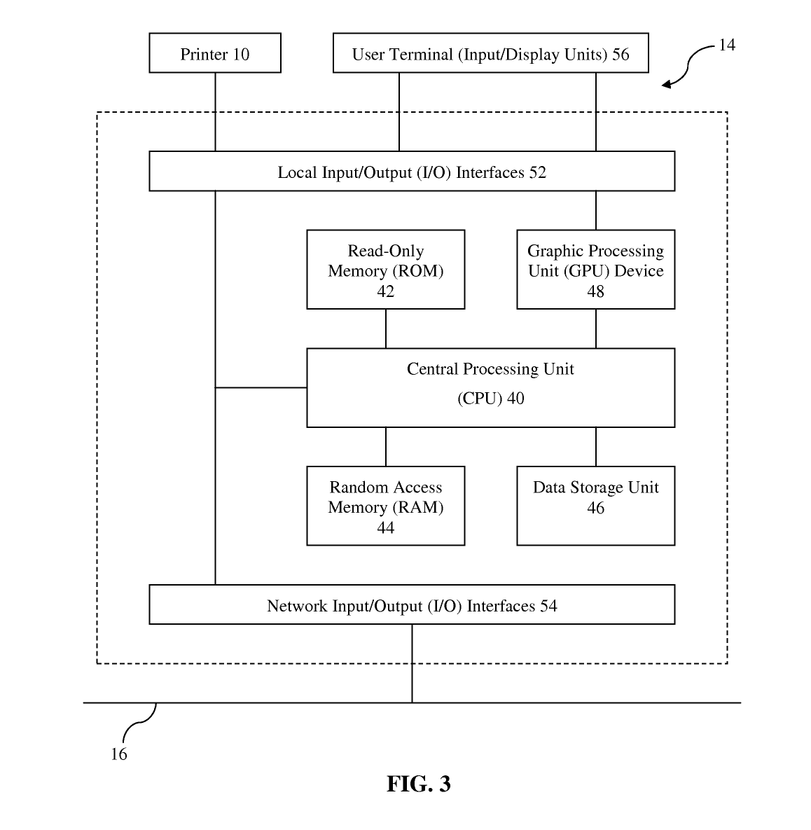

Referring to FIG. 3, there is shown a schematic block diagram illustrating an exemplary print shop computer 14 according to an embodiment of the present invention. As shown in FIG. 3, the print shop computer 14 typically includes a central processor unit (CPU) 40 that controls the function and operation of the computer 14 and execute computer instructions and programs that may be installed or saved on a ROM 42, a RAM 44, or a data storage unit 46 (such as a hard disc drive) coupled to the CPU 40. One or more user terminals 56 (each may have its display and input units) may be connected to the computer 14 to enable print shop users to interact with the computer 14 and/or the attached printer 10. Alternatively the computer 14 may have its own integrated display and input units to enable print shop users to interact with the computer 14 and/or the attached printer 10. The computer 14 typically has local input/output (I/O) interfaces 52 for connecting to the user terminal 56 and optionally connecting to a printer 10, and network I/O interfaces 54 for connection to the data communication channel 16. Through the network channel 16 the computer 14 can also be connected to the external computer network such as the Internet 18 so that the computer 14 can remotely communicate with other remote servers and computers via the Internet 18. The computer 14 also has a GPU device 48 such as a graphic card for processing graphic data or images for displaying on the display unit of the user terminal 56. Alternatively the GPU device 48 may be part of the CPU 40 or part of an IC chip that also contains the CPU 40. It is understood that the computer 14 may be any suitable computer or any suitable data processing apparatus.

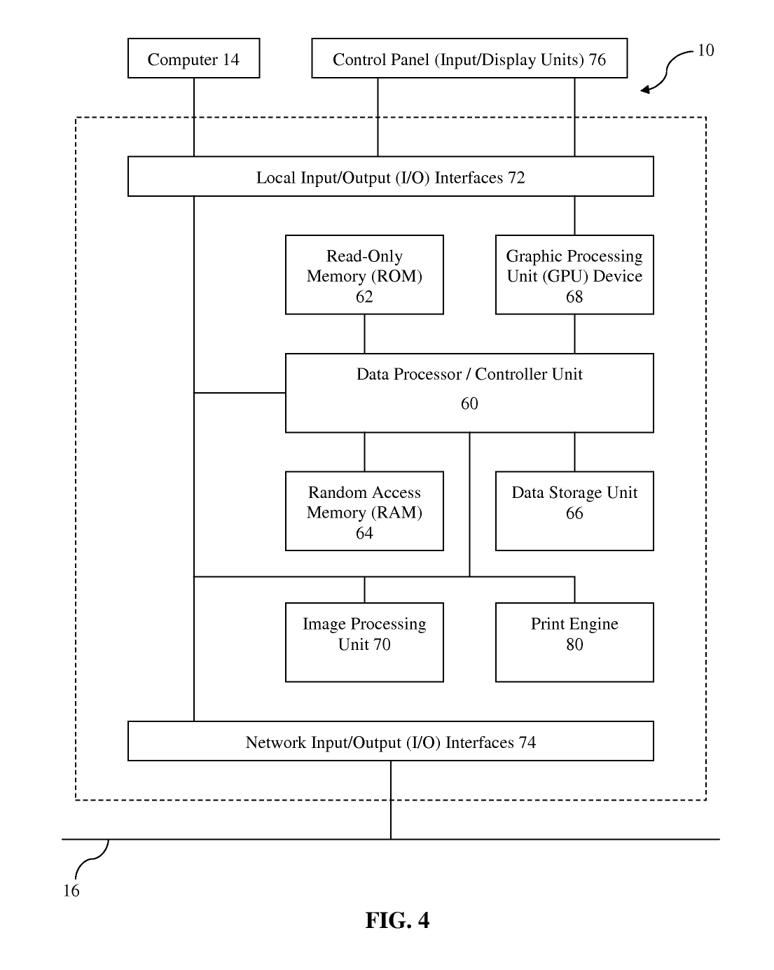

Referring to FIG. 4, there is shown a schematic block diagram illustrating an exemplary printer 10 according to an embodiment of the present invention. As also shown in FIG. 4, the printer 10 typically has a data processor or controller unit 60 which controls the other internal units of printer 10. The data processor or controller unit 60 can execute computer instructions and programs that may be installed or saved on a ROM 62, a RAM 64, or a data storage unit 66 (such as a hard disc drive) coupled to the data processor or controller unit 60. The printer 10 also has a control panel 76 that is accessible by a print shop user and may include a display unit with a display screen such as a liquid crystal display (LCD) display screen, as well as input units such as keys, buttons, touch screen, etc., for a user to communicate with and control the function and operation of printer 10. The printer 10 typically has network input/output (I/O) interfaces 74 for connection with the data channel 16, and local I/O interfaces 74 72 for connecting with the control panel 76 and optionally connecting to the local computer 14. The printer 10 also has an image processing unit 70 and a print engine 80 that are controlled by the data processor or controller unit 60. The printer 10 also has a GPU device 68 such as a graphic card for processing graphic data or images for displaying on the display unit of the control panel 76. Alternatively the GPU device 68 may be part of the data processor or controller unit 60 or part of an IC chip that also contains the data process or controller unit 60. It is understood that the image processing unit 70 may also has one or more GPUs and may be utilized for implementation of an alternative embodiment of the present invention, with the understanding that it is the GPUs in the server that are primarily utilized for implementation of the preferred embodiments of the present invention as described in detail later. It is also understood that the printer 10 may be any suitable printing device, apparatus or system.

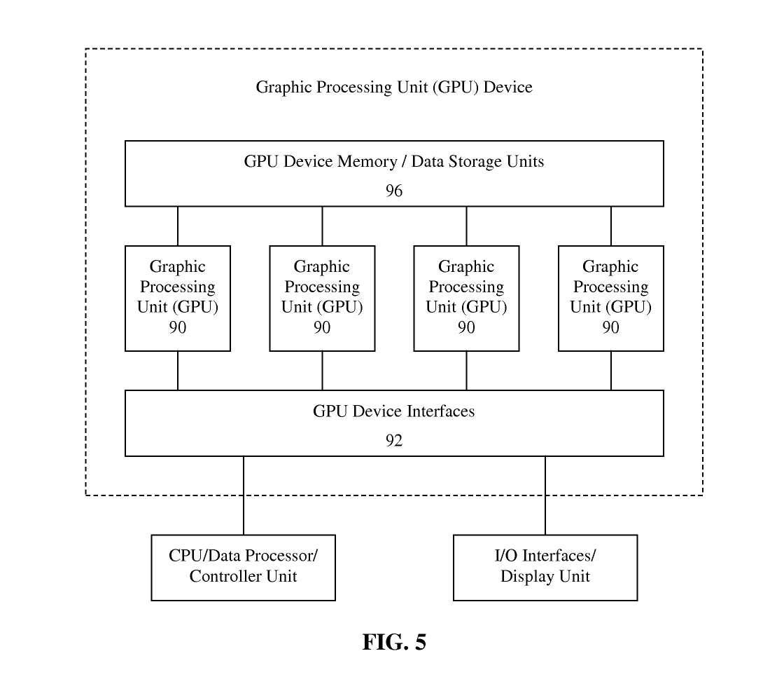

Referring to FIG. 5, there is shown a schematic block diagram illustrating an exemplary GPU device according to an embodiment of the present invention. The exemplary GPU device is representative of the GPU device 28 of the server 12, the GPU device 48 of the computer 14, and the GPU device 68 and the image processing unit 70 of the printer 10. As shown in FIG. 5, a GPU device typically has parallel GPUs 90 coupled to a memory or data storage unit 96. The parallel GPUs 90 are also connected to the GPU device interfaces 92. The GPU device is connected to the CPU of server 12 or computer 14 or the data processor/controller unit 60 of the printer 10 through its interfaces 92 from exchanging computer instruction and program codes so that the parallel GPUs can carry out the functions of the GPU device and the implement the present invention as will be described in detail below. The GPU device (except when it is the image processing unit of printer 10) is also connected to the display unit of the server 12, computer 14 or printer 10 through its interfaces 72 for displaying graphic images on the connected display unit.

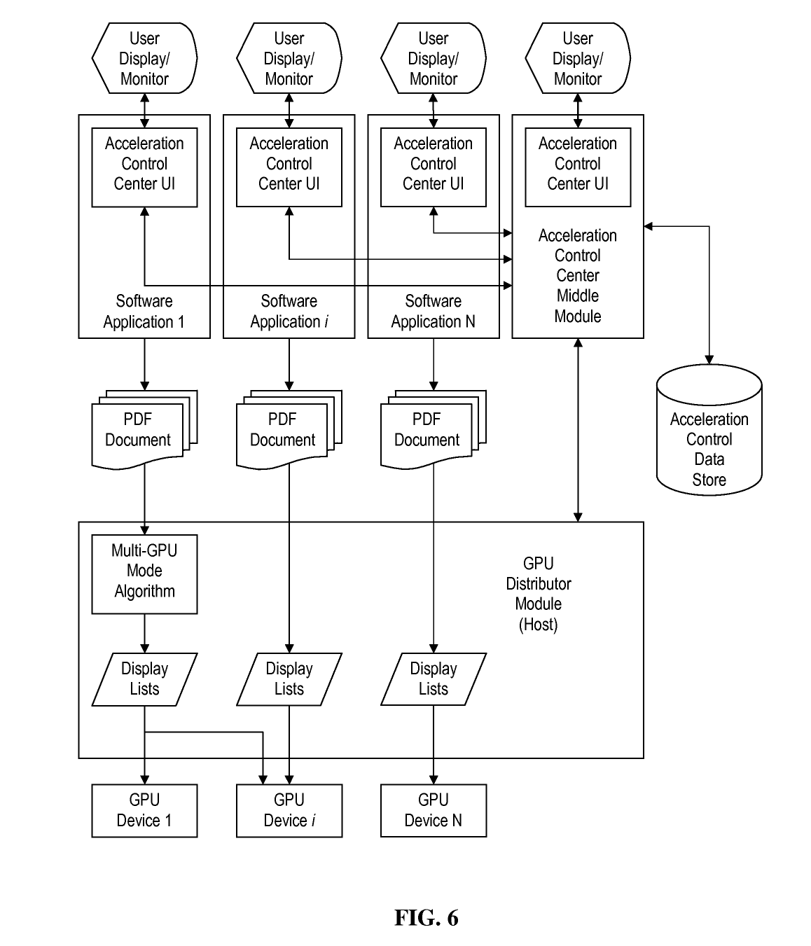

Referring to FIG. 6, there is shown a schematic flow-chart diagram illustrating an exemplary overview of a GPU accelerated control system architecture according to an embodiment of the present invention. A main component of the GPU accelerated control system architecture is the acceleration control center which allows a user to configure the GPU devices on the printing system for parallel processing tasks. The acceleration control center is a software module consisting of four sub-modules: (1) a modular user interface (UI) console box that can appear on any software application; (2) a middle-ware software module that interfaces with the UI console box, detects GPU devices within a local or distributed printing system, queries their capabilities and status, and connects with and controls a central data store; (3) a central data store for storing/retrieving control settings (input) from the UI console box; and (4) an underlying GPU distributor module that controls access to each GPU device in the printing system and executes Multi-GPU Mode processing. The first three sub-modules may be distributed, i.e., there is no limitation that all three of them have to reside on a same server or computer or printer. The UI console box may be an add-on or “plug-and-play” part of any software application 1, 2, . . . , N that are installed and running on the server 12 or computer 14 or printer 10 of the printing system for displaying control windows/dialogs on the user display/monitor of the server 12, computer 14 and/or printer 10. The central data store may be saved on the ROM, RAM and/or the data storage unit of the server 12, computer 14 and/or printer 10. The GPU distributor module can run a Multi-GPU mode algorithm which is applicable when the “Multi-GPU” mode is enabled by the user through the UI console box, and a GPU accelerated parallel image processing algorithm for utilizing parallel GPUs in the printing system to accelerate the execution of the image processing algorithm (such as color detection) on the print server As illustrated in FIG. 6, the PDF documents to be printed by the software application may be processed by parallel GPUs on one GPU device, or alternatively processed by multiple GPU devices when Multi-GPU Mode is enabled.

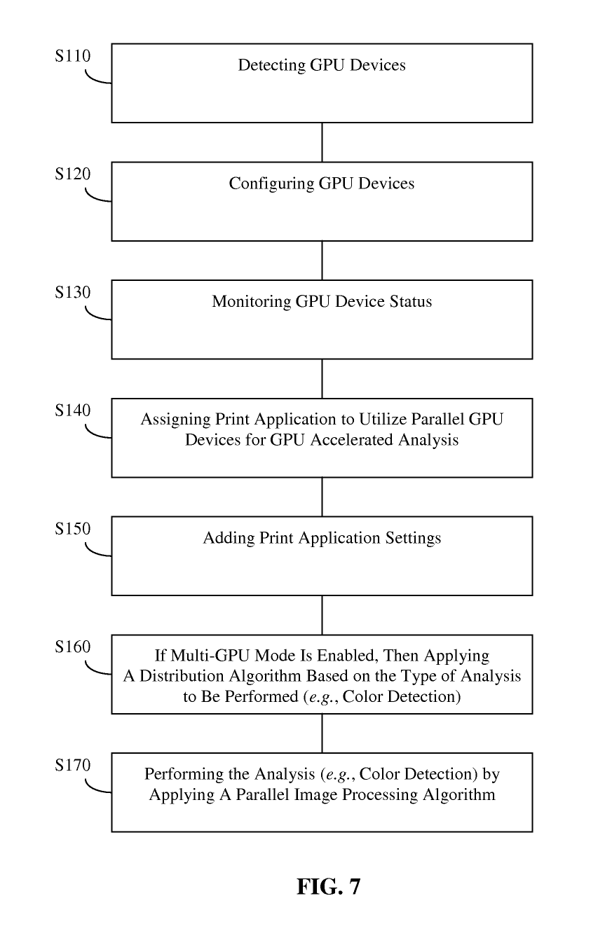

Referring to FIG. 7, there is shown a schematic flow chart diagram illustrating the steps of an exemplary process implementing a GPU accelerated color analysis method according to an embodiment of the present invention, which generally includes the basic steps of: a step of detecting GPU devices on the printing system (Step S110), configuring GPU devices on the printing system (Step S120), monitoring the status of the GPU devices on the printing system (Step S130), assigning print application to utilize parallel GPU devices for GPU accelerated analysis (Step 140), adding print application settings (Step 150), applying a distribution algorithm based on the type of analysis to be performed (e.g., color detection) if Multi-GPU Mode is enabled (Step 160), and performing the analysis (e.g., color detection) by applying a parallel image processing algorithm (Step 170).

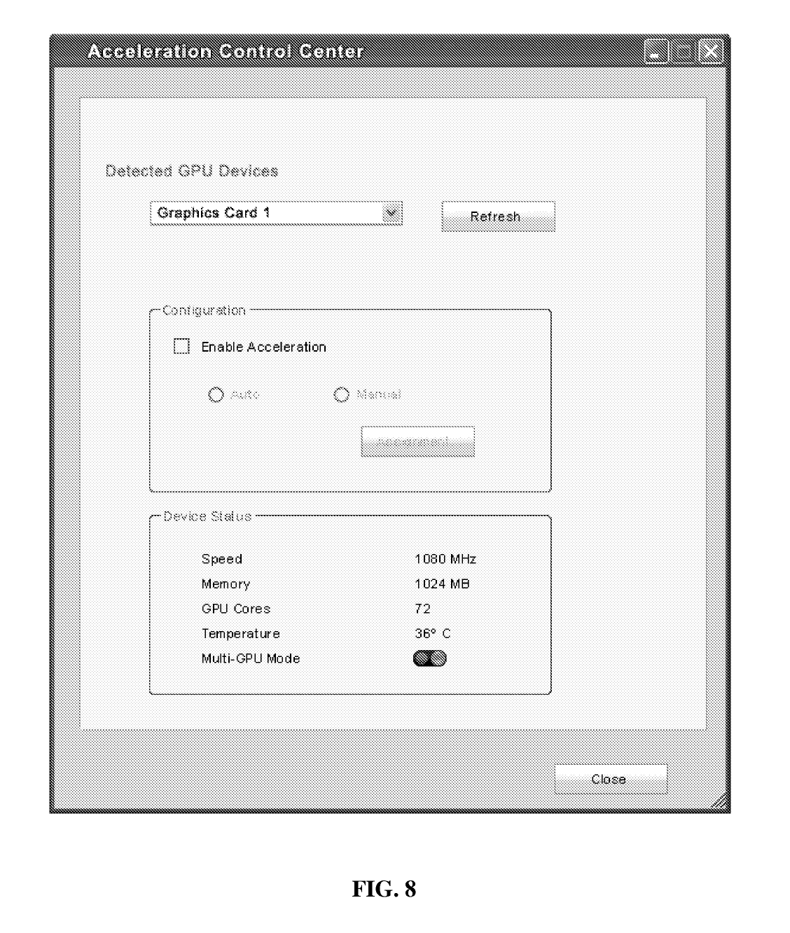

Referring to FIG. 8, there is shown a representative screen-shot diagram illustrating a main dialog window of the acceleration control center module of the software program implementing a GPU accelerated color analysis method according to an embodiment of the present invention. Shown in FIG. 8 is the default dialog where the user can select a detected device to view its status, enable acceleration, and configure application and algorithm permissions. In the box below “Detected GPU Devices”, known GPU devices within the printing system are displayed in a drop-down list. These GPU devices are detected at the startup of the acceleration control center module. The available selection list can be refreshed using the “Refresh” button.

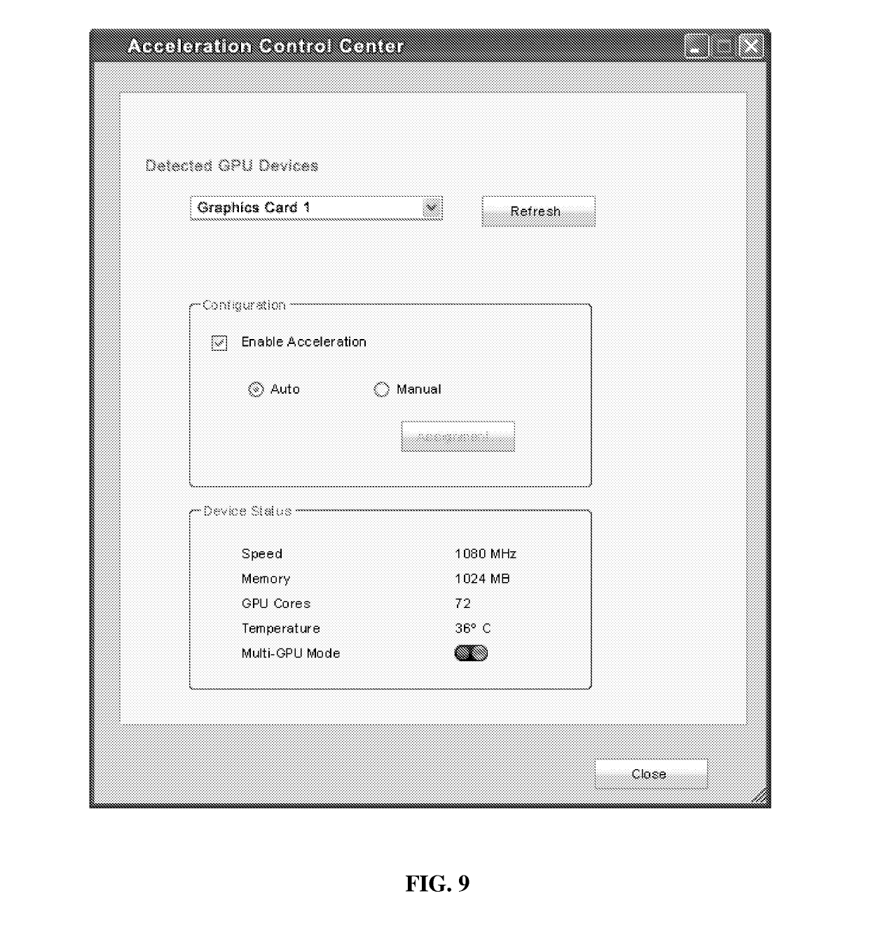

Referring to FIG. 9, there is shown a representative screen-shot diagram illustrating the main dialog window of the acceleration control center module of the software program implementing a GPU accelerated color analysis method according to an embodiment of the present invention, showing the “Auto” option of “Enable Acceleration” selected. In the “Configuration” panel, there is an “Enable Acceleration” checkbox. The GPU devices selected in the Detected GPU Devices box can be enabled for parallel processing for use by one or more applications in the printing system. Selecting the “Enable Acceleration” checkbox allows access to the “Auto”/“Manual” radio buttons (otherwise they are grayed out). Selecting the “Auto” button enables the GPU device for use by all applications. Each application is allowed to run any parallel processing algorithm and the algorithm is application dependent. However, permission for Multi-GPU Mode is not given here.

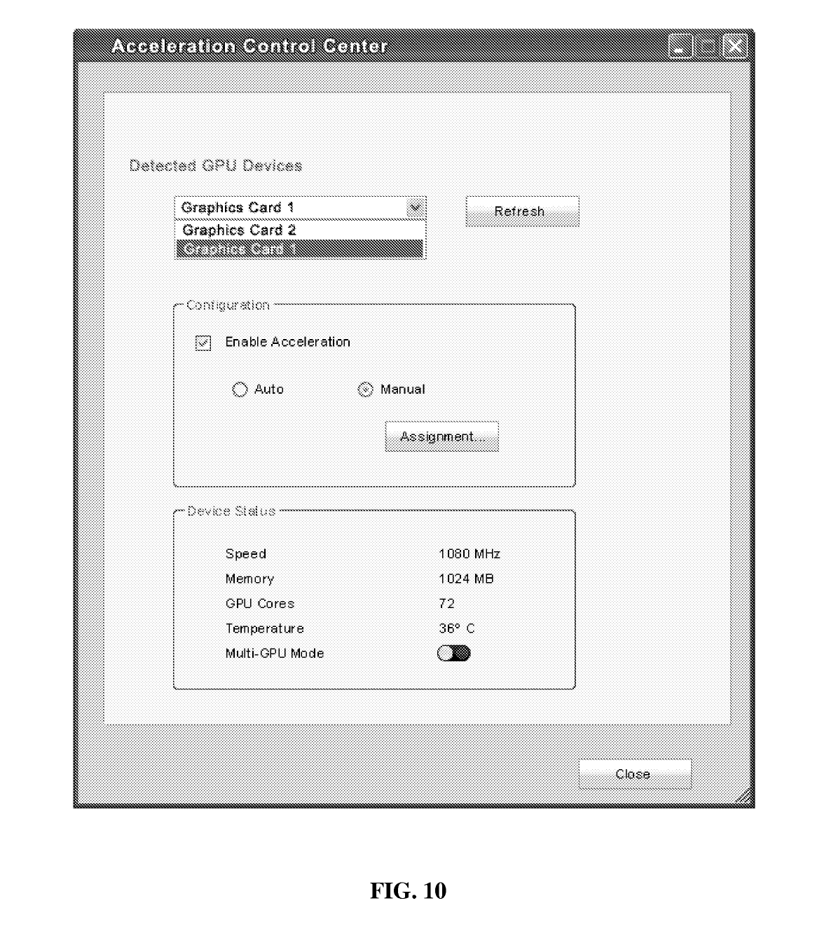

Referring to FIG. 10, there is shown a representative screen-shot diagram illustrating the main dialog window of the acceleration control center module of the software program implementing a GPU accelerated color analysis method according to an embodiment of the present invention, showing the “Manual” option of “Enable Acceleration” selected. Selecting the “Manual” button allows access to further granularity of access control (at the application-level) for managing the GPU device. Selecting the “Manual” button also allows access to the Assignment button, which is grayed out if “Manual” radio button is not selected. Selecting the “Manual” button further allows setting permission for Multi-GPU Mode.

The “Device Status” panel shown in FIG. 10 displays current device status obtained during device detection. This information is refreshed using the refresh button. Commonly known GPU device capabilities such as speed and memory are displayed. The number of GPU device cores (e.g., the number of “CUDA Cores” found in a modern NVIDIA based graphics GPU) that can be used for parallel processing is also displayed. Device status such as current known hardware temperature is also displayed to provide the user with information relevant to making decisions when performing application assignment or enabling/disabling acceleration. The temperature displayed is the last known temperature of the device (which may be refreshed). If the temperature is above a given threshold (which may be set or changed in a configuration file by the print shop or printing system operator or administrator), the print shop or printing system operator or administrator may be notified (e.g., by email). The Device Status panel also displays a “Multi-GPU Mode” indicator light, where a green light indicates that one or more applications are currently enabled to execute one or more parallel processing algorithms on the GPU device in tandem with another GPU device, and a red light indicates that no such permission is given for any application.

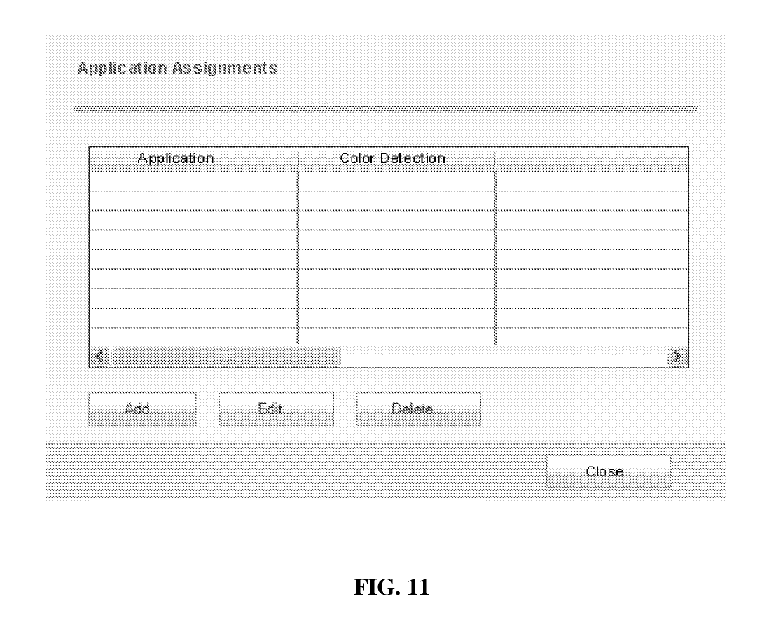

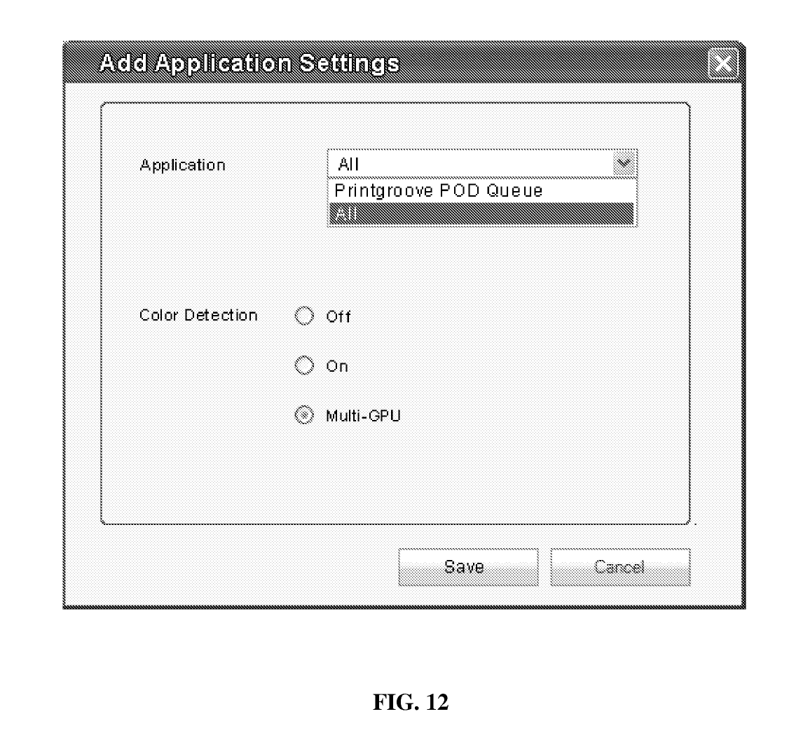

Referring to FIG. 11, there is shown a representative screen-shot diagram illustrating the application assignment dialog window of the acceleration control center module of the software program implementing a GPU accelerated color analysis method according to an embodiment of the present invention. Pressing the “Assignment” button (shown in FIG. 10) results in a “Application Assignments” popup dialog window which can be used for assigning printing applications permission to utilize the GPU device, set allowed algorithms, and give permission for use in Multi-GPU Mode operations. The “Application Assignment” dialog window displays application assignments and permissions for utilizing GPU device for select algorithms to printing applications. It displays current settings for which applications are permitted to utilize the GPU device and what algorithms are permitted to run on the GPU device for that application. In the “Application” column, the application names or ID labels to which to apply the permissions set in the subsequent columns are displayed. The value “All” will be displayed if the subsequent column permissions apply to all applications. In the next column, the algorithms to be executed for the applications listed in the first column are listed, for example, “Color Detection”. Additional columns can be added for controlling permissions to more algorithms in addition to, e.g., “Color Detection” which is merely one of many possible examples (other examples may include, e.g., parallel calculations for customer account costing computation algorithms, etc.). Under these columns permissions for performing the corresponding process (e.g., color detection) using the parallel processing algorithm are displayed. The “Add” button is used for displaying a popup dialog box (FIG. 12) used to select options for creating a new row entry in the “Application Assignments” list box. The “Edit” button is used for displaying a popup menu (not shown, similar to FIG. 12) for editing an existing, selected row entry in the “Application Assignments” list box. The “Delete” button is used for removing a selected entry from the “Application Assignments” list box.

Referring to FIG. 12, there is shown a representative screen-shot diagram illustrating the “Add Application Settings” dialog window of the acceleration control center module of the software program implementing a GPU accelerated color analysis method according to an embodiment of the present invention. A user may select a known printing application from the drop-down menu to which the subsequent settings will apply. The user may alternatively select “All” which designates all applications. For a process to be performed, as listed in one of the columns shown in FIG. 11 (e.g., “Color Detection”, which is merely one of many examples of possible current or future algorithms that can be added to this dialog with selections “Off”, “On”, or “Multi-GPU”), permissions to GPU device access by the designated application may be selected as “Off”, “On” or “Multi-GPU”. When “Off” is selected, no permission to GPU device access is granted. When “On is selected, permission to GPU device access is granted. When “Multi-GPU” is selected, permission to GPU device access is granted and can be executed using one GPU device in parallel with other detected GPU devices simultaneously for which the same application is enabled (for an application to be able to run Multi-GPU Mode, it must be enabled for Multi-GPU mode on two or more GPU devices).

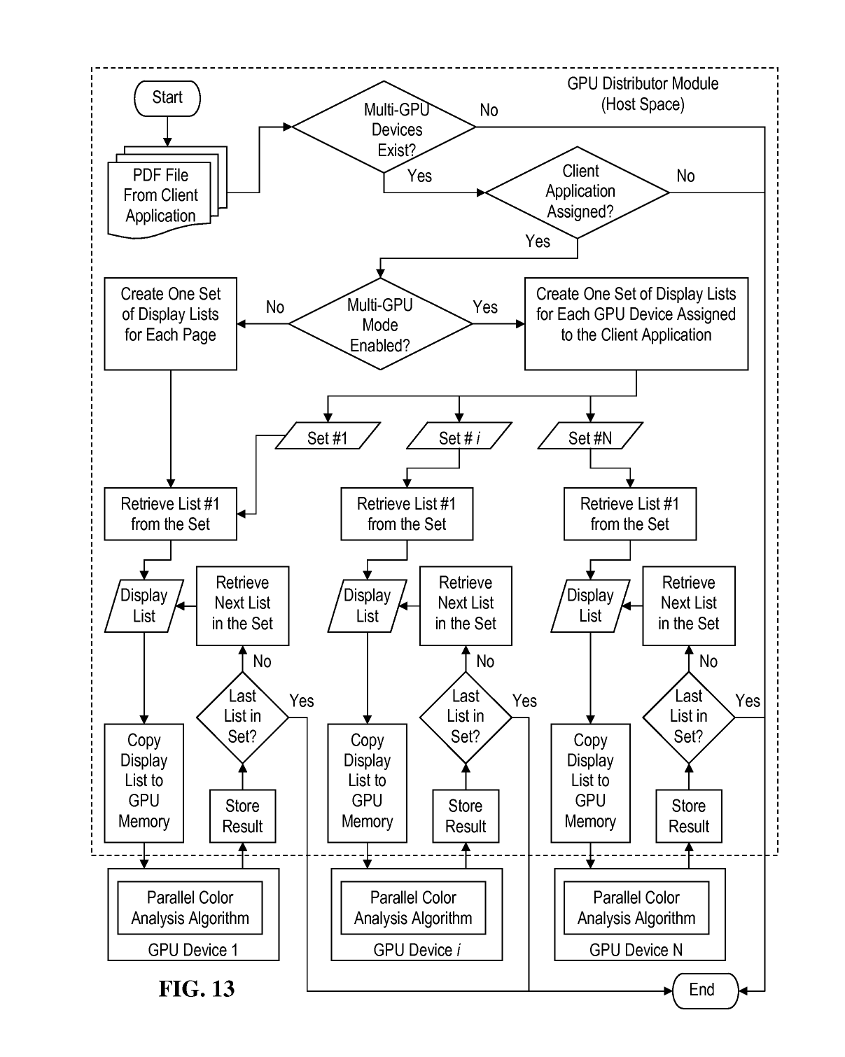

Referring to FIG. 13, there is shown a schematic flow-chart diagram illustrating an exemplary distribution algorithm under the “Multi-GPU” mode based for an exemplary type of color analysis, according to an embodiment of the present invention. When two or more GPU devices are enabled for an application (using the Acceleration Control Center module), the GPU Distributor module invokes a distribution algorithm based on the type of processing required. For example, in the case of the “Color Detection” algorithm, the pages are split based on the number of GPU devices available and their capabilities. As shown in the exemplary process illustrated in FIG. 13, when a PDF file from a printing application needs to be processed, the algorithm will first query whether one or more GPU devices exist in the printing system. If there is none, then the process ends. If one or more GPU devices exist, then the algorithm will query whether the printing application is assigned to the GPU devices. If not, then the process ends. If yes, the algorithm will next query whether “Multi-GPU” Mode is enabled. If not, then the color detection will be performed by the one GPU device assigned to this application (e.g. GPU device 1 shown in the flow chart).

When the “Multi-GPU” Mode is not enabled, the algorithm will first create a set of

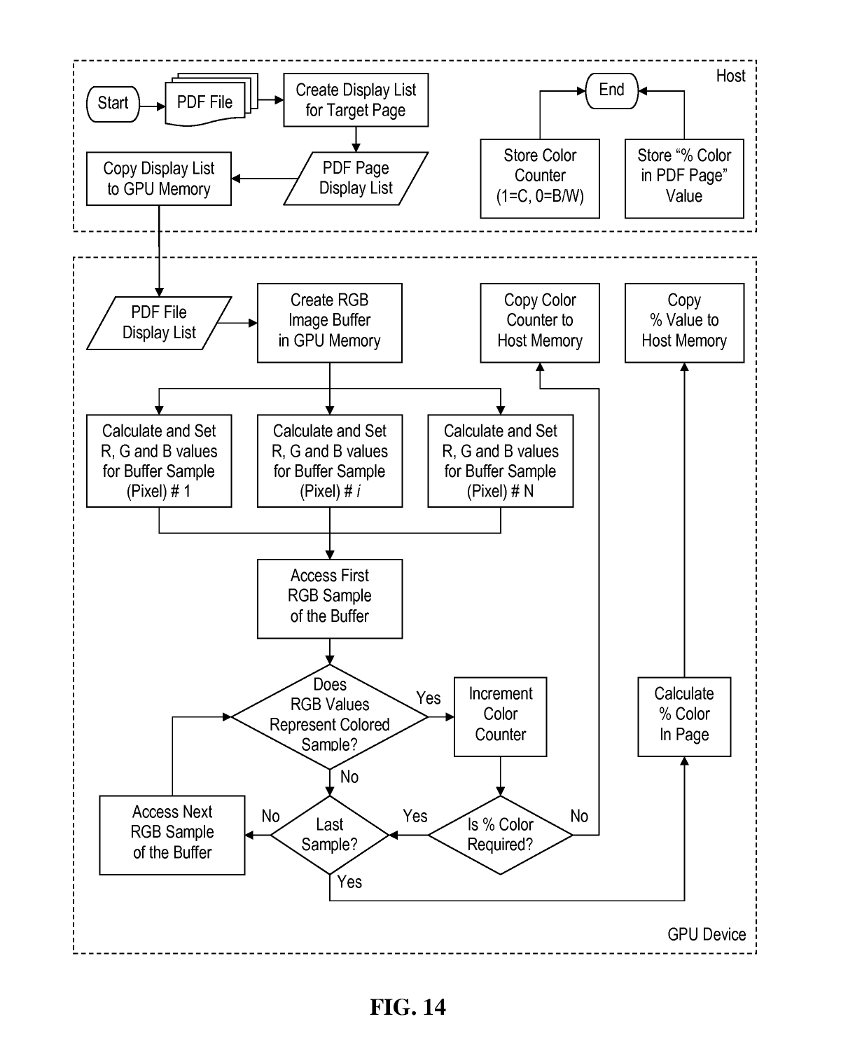

Display Lists (“DL”) (one DL for each PDF page). The first DL is retrieved from the set and copied to the memory unit of the assigned GPU device, whereupon the GPU device will perform a parallel color analysis algorithm (shown in FIG. 14). The result is saved and the next DL will be processed similarly, until all DLs in the set are processed, at which point the process ends. When the “Multi-GPU” Mode is enabled, the algorithm will first create a set of DLs for each GPU device assigned to the application. For example, if there are three (3) GPU devices assigned to the application and all are Multi-GPU Mode enabled, then three (3) sets of DLs will be created, one set for each GPU device. The number of DLs in each set equals to the number of pages in the PDF file divided by the number of GPU device enabled (because each PDF page has one DL). Next, each set of DLs is sent to an assigned GPU device. For example, Set 1 is sent to GPU Device 1, Set 2 is sent to GPU Device 2, and Set 3 is sent to GPU Device 3. Then each GPU-device processes the set similarly, as follows: the first DL is retrieved from the set and copied to the memory unit of the corresponding GPU device, whereupon the GPU device will perform a parallel color analysis algorithm (shown in FIG. 14); the result is saved and the next DL will be processed similarly, until all DLs in the set are processed, at which point the process on this corresponding GPU device ends.

Referring to FIG. 14, there is shown a schematic flow-chart diagram illustrating an exemplary GPU accelerated parallel image processing algorithm for an exemplary color detection analysis, according to an embodiment of the present invention. As an example, a parallel color detection algorithm is shown here, representing the parallel image processing algorithm which is used by applications to obtain the percentage value of color in a given PDF page. Alternatively, the algorithm can simply determine whether the page is color or black and white by a “short circuit” technique where the algorithm returns the result immediately upon the first detection of a colored pixel. The top part of the flow chart steps denotes runtime memory spaces in host device such as the server 12, where the bottom part of the flow chart steps denotes runtime memory spaces in the GPU device. As shown in the exemplary process illustrated in FIG. 14, when a PDF file from a printing application is to be processed, the host will first create a DL for each page of the PDF file. Working on one page at a time, the DL of the page is copied to the memory unit of the GPU device. The GPU device will first create an RGB image buffer in the GPU device memory, and then the multiple GPUs of the GPU device will, in parallel manner, create and set R, G and B values for buffer samples (pixels). For example, GPU 1 of the GPU device will create and set R, G and B values for buffer sample (pixel) 1, while GPU 2 of the same GPU device will create and set R, G and B values for buffer sample (pixel) 2, and so on. This parallel execution is the key for the acceleration in this color detection process. From the RGB samples created and set by the parallel GPUs, the algorithm begins querying whether colored sample (pixel) exists. As the first RGB sample is accessed, the algorithm will query whether the RGB values represent colored sample. If no, the next sample will be examined. If yes, then an color counter is incremented. If a percentage of color contents in the corresponding PDF page needs to be determined, then all RGB samples need to be examined, and the algorithm will then calculate the percentage of color contents, which equals to the number of color samples divided by the total number of buffer samples (then times 100). This color percentage is then copied to the host memory and stored as the “percentage color in the PDF page” value for that PDF page, and the process ends. If there is no need to determine the percentage of color contents in the corresponding PDF page, then as soon as a color sample is found, the value of the color counter (which will be 1) will be copied to the host memory, and the process ends. Of course if at the end of the process no color sample is found, then the value of the color counter will be 0 (meaning the corresponding PDF page is a black and white page), which will also be copied to the host memory, and the process also ends.

The present invention may be implemented on many printing system software programs and/or applications, and any current or future applications requiring high throughput for analyzing PDF or other types of documents with centralized control or parallel processing algorithms.

The main features of the present invention include: (1) a centralized, user configurable control module for detecting GPU devices, analyzing GPU device capabilities, assigning applications; (2) the ability to distribute image processing/color analysis workload to multiple GPU devices based on type of parallel processing algorithm required by printing applications (i.e. stacking multiple processing devices in a Scalable Link Interface (“SLI”)-like configuration); (3) the ability to use GPU device for generating and analyzing PDF page raster images in memory for the purpose of, for example, detecting colored samples and percentage of color in PDF pages; (4) the ability to divide a PDF document into “sets of pages” for concurrent processing on multiple GPU devices; and (5) real-time GPU device feedback to provide information for user to make decisions for GPU device assignment.

The above described exemplary system, method and process of the preferred embodiments of the present invention has many advantages. It provides an ability to manage and configure a GPU device (or multiple devices similar to a Scalable Link Interface (SLI)-type configuration) on an application-level (such that a user can view GPU status and allocate GPU devices to different applications and algorithms). This implementation can be leveraged across multiple products, servers, and applications (including cloud computing environments) that require raster image processing. The cost of acquiring discrete GPU hardware to implement the present invention method is minimal for developers and customers. The present invention also provides a managed ability to divide PDF documents into “sets of pages” for concurrent processing on multiple GPU devices to facilitate “high throughput” of image/color data. Under this approach, PDF page rasterization and subsequent analysis is moved to GPU space (using GPU processor and memory) to free system CPU and memory for other system processes and applications. This provides an ability to leverage massively parallel processing techniques for significant performance improvement for page-level color processing (as one example of the applications of the present invention method).

It will be apparent to those skilled in the art that various modification and variations can be made to the methods of the present invention without departing from the spirit or scope of the invention. Thus, it is intended that the present invention cover modifications and variations that come within the scope of the appended claims and their equivalents.

What is claimed is:

1. A method for utilizing multiple graphic processor unit (GPU) devices in a printing system, comprising the steps of:
a. configuring the multiple GPU devices to enable multiple applications to be executed by the GPU devices, the multiple applications being used for GPU accelerated image analysis;
b. assigning the multiple applications to the multiple GPU devices in accordance with the configurations of the multiple GPU devices; and
c. having the multiple GPU devices execute the assigned applications in parallel, thereby performing the GPU accelerated image analysis.

2. The method according to claim 1, further comprising a step of detecting GPU devices existing in the printing system.

3. The method according to claim 1, further comprising a step of monitoring the GPU devices in the printing system.

4. The method according to claim 1, wherein the configuration step enables a GPU device for use in GPU accelerated image analysis.

5. The method according to claim 4, wherein the configuration step automatically enables a GPU device for use by all printing applications in GPU accelerated image analysis.

6. The method according to claim 4, wherein the configuration step manually enables a GPU device for use by assigned printing applications in parallel analysis.

7. The method according to claim 1, wherein the configuration step further comprises a sub-step of adding application settings.

8. The method according to claim 7, wherein the application settings comprises an “OFF” setting which denies permission to the assigned application of performing the GPU accelerated image analysis.

9. The method according to claim 7, wherein the application settings comprises an “ON” setting which grants permission to the assigned application of performing the GPU accelerated image analysis.

10. The method according to claim 7, wherein the application settings comprises an “Multi-GPU” setting which grants permission to the assigned application of simultaneously utilizing two or more enabled GPU devices to perform the GPU accelerated image analysis.

11. The method according to claim 10, further comprising a step of utilizing a GPU distribution process for performing the GPU accelerated image analysis by two or more enabled GPU devices simultaneously.

12. The method according to claim 7, wherein the application settings comprises an algorithm setting which indicates what algorithm is permitted to run on the multiple GPU devices for the assigned application.

13. A system for utilizing multiple graphic processor unit (GPU) devices in a printing system comprising at least one data processing apparatus having a non-transitory memory storing a computer software program and a processor executing the computer software program, wherein the computer software program includes program code configured to cause the at least one data processing apparatus to execute a process which comprises the steps of:
a. configuring the multiple GPU devices to enable multiple applications to be executed by the GPU devices, the multiple applications being used for GPU accelerated image analysis;
b. assigning the multiple applications to the multiple GPU devices in accordance with the configurations of the multiple GPU devices; and
c. having the multiple GPU devices execute the assigned applications in parallel, thereby performing the GPU accelerated image analysis.

14. The system according to claim 13, wherein the process further comprises a step of detecting GPU devices existing in the printing system.

15. The system according to claim 13, wherein the process further comprises a step of monitoring the GPU devices in the printing system.

16. The system according to claim 13, wherein the configuration step of the process enables a GPU device for use in GPU accelerated image analysis.

17. The system according to claim 16, wherein the configuration step of the process automatically enables a GPU device for use by all printing applications in GPU accelerated image analysis.

18. The method according to claim 16, wherein the configuration step of the process manually enables a GPU device for use by assigned printing applications in parallel analysis.

19. The method according to claim 13, wherein the configuration step of the process further comprises a sub-step of adding application settings.

20. The system according to claim 19, wherein the application settings comprises an “OFF” setting which denies permission to the assigned application of performing the GPU accelerated image analysis.

21. The system according to claim 19, wherein the application settings comprises an “ON” setting which grants permission to the assigned application of performing the GPU accelerated image analysis.

22. The system according to claim 19, wherein the application settings comprises an “Multi-GPU” setting which grants permission to the assigned application of simultaneously utilizing two or more enabled GPU devices to perform the GPU accelerated image analysis.

23. The system according to claim 22, wherein the process further comprises a step of utilizing a GPU distribution process for performing the GPU accelerated image analysis by two or more enabled GPU devices simultaneously.

24. The system according to claim 19, wherein the application settings comprises an algorithm setting which indicates what algorithm is permitted to run on the multiple GPU devices for the assigned application.

25. A computer software program product having a computer readable program code embedded in a computer usable non-transitory storage medium for controlling at least one data processing apparatus, the computer readable program code configured to cause the at least one data processing apparatus to execute a process which comprises the steps of:
a. configuring the multiple GPU devices to enable multiple applications to be executed by the GPU devices, the multiple applications being used for GPU accelerated image analysis;
b. assigning the multiple applications to the multiple GPU devices in accordance with the configurations of the multiple GPU devices; and
c. having the multiple GPU devices execute the assigned applications in parallel, thereby performing the GPU accelerated image analysis.

26. The computer software program product according to claim 25, wherein the process further comprises a step of detecting GPU devices existing in the printing system.

27. The computer software program product according to claim 25, wherein the process further comprises a step of monitoring the GPU devices in the printing system.

28. The computer software program product according to claim 25, wherein the configuration step of the process enables a GPU device for use in GPU accelerated image analysis.

29. The computer software program product according to claim 28, wherein the configuration step of the process automatically enables a GPU device for use by all printing applications in GPU accelerated image analysis.

30. The computer software program product according to claim 28, wherein the configuration step of the process manually enables a GPU device for use by assigned printing applications in parallel analysis.

31. The computer software program product according to claim 25, wherein the configuration step of the process further comprises a sub-step of adding application settings.

32. The computer software program product according to claim 31, wherein the application settings comprises an “OFF” setting which denies permission to the assigned application of performing the GPU accelerated image analysis.

33. The computer software program product according to claim 31, wherein the application settings comprises an “ON” setting which grants permission to the assigned application of performing the GPU accelerated image analysis.

34. The computer software program product to claim 31, wherein the application settings comprises an “Multi-GPU” setting which grants permission to the assigned application of simultaneously utilizing two or more enabled GPU devices to perform the GPU accelerated image analysis.

35. The computer software program product according to claim 34, wherein the process further comprises a step of utilizing a GPU distribution process for performing the GPU accelerated image analysis by two or more enabled GPU devices simultaneously.

36. The computer software program product according to claim 31, wherein the application settings comprises an algorithm setting which indicates what algorithm is permitted to run on the multiple GPU devices for the assigned application.
